(19) United States
(12) Patent Application Publication
(10) Pub. No.: US 2025/0225502 A1
(43) Pub. Date: Jul. 10, 2025

(54) CARD RENEWAL MACHINE

(71) Applicant: Giesecke+Devrient ePayments GmbH, Munich (DE)

(72) Inventor: Anand NINORIYA, Pune (IN)

(21) Appl. No.: 19/009,540

(22) Filed: Jan. 3, 2025

(30) Foreign Application Priority Data
Jan. 5, 2024 (IN) 202411001070

(51) Int. Cl. G06Q 20/34; B26F 1/02

(52) U.S. Cl. CPC G06Q 20/354; B26F 1/02

(57) ABSTRACT

The present disclosure relates to a card renewal machine. The machine comprises a card reader to extract card details pertaining to a card inserted within the machine, and a processing device in communication with a central server associated with one or more card issuers. The processing device is configured to retrieve, from the central server, user details of a registered user associated with the inserted card based on the extracted card details, authenticate, using authentication modes, the inserted card and the registered user based on the extracted card details and/or the retrieved user details, and extract an expiration date of the received card from the extracted card details. Further, the machine destroys/deactivates the card and generates a new card upon expiration of the inserted card and/or upon receiving a card renewal request from the user.

### TECHNICAL FIELD

The present disclosure relates generally to the field of card renewal machines. In particular, the present disclosure relates to a simple, secured, and easy-to-use machine for renewing cards such as debit cards, credit cards, and smart cards, which provides cardholders/users with a new card while deactivating or destroying the older card.

### BACKGROUND

Background description includes information that may be useful in understanding the present invention. It is not an admission that any of the information provided herein is prior art or relevant to the presently claimed invention, or that any publication specifically or implicitly referenced is prior art.

Debit and credit cards are essential financial instruments that facilitate electronic transactions for individuals and businesses. To ensure the security and integrity of financial transactions, banking institutions often mandate the expiration of these cards after a stipulated period. Cardholders are then required to renew their cards to continue using banking services seamlessly.

The conventional process for card renewal involves the banking branch or card issuers sending the new card to the cardholder's registered address via courier services. However, the reliability and predictability of the delivery process are major concerns. The delivery time may vary, leading to delays in the cardholder receiving the new card. During this transition period, the existing card may remain active, posing security risks and increasing the chances of unauthorized access or misuse.

Additionally, the conventional card renewal process is time-consuming and reliant on human intervention. Customers may fail to destroy or dispose of their existing cards properly, leading to potential security breaches. Furthermore, the manual handling of card renewal processes increases the likelihood of errors and compromises the overall efficiency of the system.

Moreover, the existing solutions for card renewal expose sensitive customer details to potential leaks or unauthorized access. Expired or lost cards, if not promptly replaced, can be exploited by malicious entities, jeopardizing the security and privacy of the cardholder.

There is, therefore, a need to overcome the above-mentioned drawbacks, limitations, and shortcomings associated with existing card renewal solutions, by providing a simple, secured, and easy-to-use solution for renewing expired or older cards, which provides cardholders with a new card and simultaneously deactivates or destroys the expired or old card.

### Objects of the Present Disclosure

Some of the objects of the present disclosure, which at least one embodiment herein satisfy are as listed hereinbelow.

It is an object of the present disclosure to overcome the above drawbacks, shortcomings, and limitations associated with existing card renewal solutions.

It is an object of the present disclosure to establish a secure and timely renewal process for debit/credit/smart cards, ensuring that the transition from the old to the new card occurs seamlessly and without compromising the security of the cardholder's financial information.

It is an object of the present disclosure to develop an automated machine that minimizes human intervention in the card renewal process, reducing the chances of errors and improving overall efficiency, thereby streamlining the renewal workflow, from card deactivation to the delivery of the new card to the cardholder.

It is an object of the present disclosure to devise a secure mechanism for deactivating the existing card promptly upon expiration or upon cardholder's request, reducing the window of vulnerability associated with the traditional renewal process.

It is an object of the present disclosure to provide robust privacy protection measures and data security protocols throughout the card renewal process to eliminate the risks associated with cardholder details exposure, ensuring that sensitive information remains confidential and protected from unauthorized access.

It is an object of the present disclosure to establish efficient communication channels between the banking institution/card issuers and the cardholders.

It is an object of the present disclosure to design a user-friendly interface for cardholders to manage and monitor the card renewal process effortlessly.

It is an object of the present disclosure to provide a simple, secured, and easy-to-use solution for renewing expired or old cards, in the form of a kiosk or machine that provides cardholders with a new card and simultaneously deactivates or destroys the expired or old card.

While various embodiments of the present disclosure have been elaborated for renewing and destroying the inserted cards upon expiration of the corresponding card, however, the machine may also renew and destroy a non-expired card, a predefined time period before the actual expiration date upon receiving a renewal request from the registered user or from the card issuer, and all such embodiments are well within the scope of the present disclosure.

### SUMMARY

The present disclosure relates to the field of card renewal machines. In particular, the present disclosure relates to a simple, secured, and easy-to-use machine for renewing expired or old debit/credit/smart cards, which provides cardholders/users with a new card while deactivating or destroying the expired or old card.

An aspect of the present disclosure pertains to a card renewal machine. The machine comprises a card reader configured to receive and extract one or more card details pertaining to a card inserted within the machine, and a processing device in communication with a central server associated with one or more card issuers. The processing device is operatively coupled to the card reader. Further, the processing device is configured to receive, from the card reader, the extracted card details pertaining to the inserted card, retrieve, from the central server, one or more user details of a registered user associated with the inserted card based on the extracted card details, authenticate, using one or more authentication modes, the inserted card and the registered user based on the extracted card details and/or the retrieved user details, and extract an expiration date of the received card from the extracted card details and correspondingly mark the received card as an expired card upon completion of the expiration date. Furthermore, the machine is configured to destroy or deactivate the inserted card and generate a new card upon expiration of the inserted card and/or upon receiving a card renewal request from the authenticated user.

In an aspect, the machine may comprise a hole-punching device operatively coupled to the processing device. The processing device may be configured to actuate the hole-punching device to receive the card from the card reader and further punch one or more holes in a chip-set area or magnetic strip area of the card upon expiration of the inserted card and/or upon receiving the card renewal request. The machine may be configured to transfer the card having the punched hole to an expired card collection tray enclosed within the machine.

In an aspect, the machine may comprise a card printing and embossing device operatively coupled to the processing device. The processing device may be configured to actuate the card printing and embossing device to receive the new card from a card container storing one or more new cards and print and/or emboss one or more new card details and/or at least one of the user details of the registered user on the new card upon receiving the card renewal request from the authenticated user.

In an aspect, the machine may comprise an ejector configured with the card printing and embossing device and operatively coupled to the processing device. The processing device may be configured to actuate the ejector to eject the printed and/or embossed card out of the machine to the registered user.

In an aspect, the processing device may be configured to map the one or more new card details with the user details of the registered user and correspondingly transmit the mapped data to the central server. The central server or the one or more issuers may update the card details of the destroyed/deactivated card with the mapped data or the one or more new card details.

In an aspect, the machine may comprise a human-machine interface (HMI) comprising an input unit and a display unit, operatively coupled to the processing device. The HMI may be configured to allow the registered user to send the card renewal request to the processing device and facilitate in completing the authentication during the one or more authentication modes.

In an aspect, the machine may comprise a housing accommodating one or more components of the machine. The housing may comprise a card insert slot that allows the user to insert the card to be renewed within the machine. The card reader may be positioned within the housing behind or adjacent to the card insert slot to receive the inserted card. The housing may further comprise a card ejection slot that may allow the ejection of the new card out of the machine into a tray. The card printing and embossing device and the ejector may be positioned within the housing behind or adjacent to the card ejection slot.

In an aspect, the processing device may be configured to generate and display, on the HMI, a request to the user for entering a unique PIN associated with the card upon inserting the card within the machine, where the HMI allows the user to enter the PIN. Further, the processing device may compare the entered PIN with a pre-stored registered PIN associated with the corresponding card and correspondingly authenticate the card and the user upon a positive matching of the entered PIN with the pre-stored registered PIN.

In an aspect, the processing device may be configured to generate and transmit, on a registered mobile device associated with the registered user of the inserted card, a unique one-time password (OTP) upon the positive matching. The HMI may allow the user to enter the OTP, compare the entered OTP with the transmitted OTP to authenticate the respective user, and print or emboss the new card and allow the user to collect the printed and/or embossed new card from the machine upon a positive authentication of the user.

In an aspect, the processing device may be configured to generate an alert and eject the inserted card out of the machine upon a negative matching of the entered PIN with the pre-stored registered PIN.

Various objects, features, aspects, and advantages of the present disclosure will become more apparent from the following detailed description of preferred embodiments, along with the accompanying drawing figures in which like numerals represent like features.

Within the scope of this application, it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible

### BRIEF DESCRIPTION OF DRAWINGS

The accompanying drawings are included to provide a further understanding of the present invention and are incorporated in and constitute a part of this specification. The drawings illustrate exemplary embodiments of the present invention and, together with the description,

FIG. 1 illustrates an exemplary block diagram of the proposed card renewal machine or kiosk, in accordance with an embodiment of the present disclosure.

FIG. 2 illustrates an exemplary network architecture comprising the proposed card renewal machine, a central server associated with card issuers, and mobile device(s) of registered users/cardholders, in accordance with an embodiment of the present disclosure

FIG. 3 illustrates an exemplary representation depicting the steps of generating a new card and destroying/deactivating the expired card by the proposed machine, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of the embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

The present disclosure overcomes the above drawbacks, shortcomings, and limitations associated with the existing card renewal solutions, by providing a simple, secured, and easy-to-use machine or kiosk for renewing expired or old cards, which provides cardholders with a new card and simultaneously deactivates or destroys the expired or old card.

In an aspect, the present disclosure elaborates upon a card renewal machine. The machine includes a card reader configured to receive and extract one or more card details pertaining to a card inserted within the machine, and a processing device in communication with a central server associated with one or more card issuers. The processing device is operatively coupled to the card reader. Further, the processing device is configured to receive, from the card reader, the extracted card details pertaining to the inserted card, retrieve, from the central server, one or more user details of a registered user associated with the inserted card based on the extracted card details, authenticate, using one or more authentication modes, the inserted card and the registered user based on the extracted card details and/or the retrieved user details, and extract an expiration date of the received card from the extracted card details and correspondingly mark the received card as an expired card upon completion of the expiration date. Furthermore, the machine is configured to destroy or deactivate the inserted card and generate a new card upon expiration of the inserted card and/or upon receiving a card renewal request from the authenticated user.

In an embodiment, the machine can include a hole-punching device operatively coupled to the processing device. The processing device can be configured to actuate the hole-punching device to receive the inserted card from the card reader and further punch one or more holes in a chip-set area or magnetic strip area of the card upon receiving the card renewal request to destroy the card. The machine can be configured to transfer the card having the punched hole to an expired card collection tray enclosed within the machine.

In an embodiment, the machine can include a card printing and embossing device operatively coupled to the processing device. The processing device can be configured to actuate the card printing and embossing device to receive the new card from a card container storing one or more new cards and print and/or emboss one or more new card details and/or at least one of the user details of the registered user on the new card upon receiving the card renewal request from the authenticated user.

In an embodiment, the machine can include an ejector configured with the card printing and embossing device and operatively coupled to the processing device. The processing device can be configured to actuate the ejector to eject the printed and/or embossed card out of the machine to the registered user.

In an embodiment, the processing device can be configured to map the one or more new card details with the user details of the registered user and correspondingly transmit the mapped data to the central server. The central server or the one or more issuers can update the card details of the old card with the mapped data or the one or more new card details.

In an embodiment, the machine can include a human-machine interface (HMI) including an input unit and a display unit, operatively coupled to the processing device. The HMI can be configured to allow the registered user to send the card renewal request to the processing device and facilitate completing the authentication during the one or more authentication modes.

In an embodiment, the machine can include a housing accommodating one or more components of the machine. The housing can include a card insert slot that allows the user to insert the card to be renewed within the machine. The card reader can be positioned within the housing behind or adjacent to the card insert slot to receive the inserted card. The housing can further include a card ejection slot that can allow the ejection of the new card out of the machine into a tray. The card printing and embossing device and the ejector can be positioned within the housing behind or adjacent to the card ejection slot.

In an embodiment, the processing device can be configured to generate and display, on the HMI, a request to the user for entering a unique PIN associated with the card upon inserting the card within the machine, where the HMI allows the user to enter the PIN. Further, the processing device can compare the entered PIN with a pre-stored registered PIN associated with the corresponding card and correspondingly authenticate the card and the user upon a positive matching of the entered PIN with the pre-stored registered PIN.

In an embodiment, the processing device can be configured to generate and transmit, on a registered mobile device associated with the registered user of the inserted card, a unique one-time password (OTP) upon the positive matching. The HMI can allow the user to enter the OTP, compare the entered OTP with the transmitted OTP to authenticate the respective user, and print or emboss the new card and allow the user to collect the printed and/or embossed new card from the machine upon a positive authentication of the user.

In an embodiment, the processing device can be configured to generate an alert and eject the inserted card out of the machine upon a negative matching of the entered PIN with the pre-stored registered PIN.

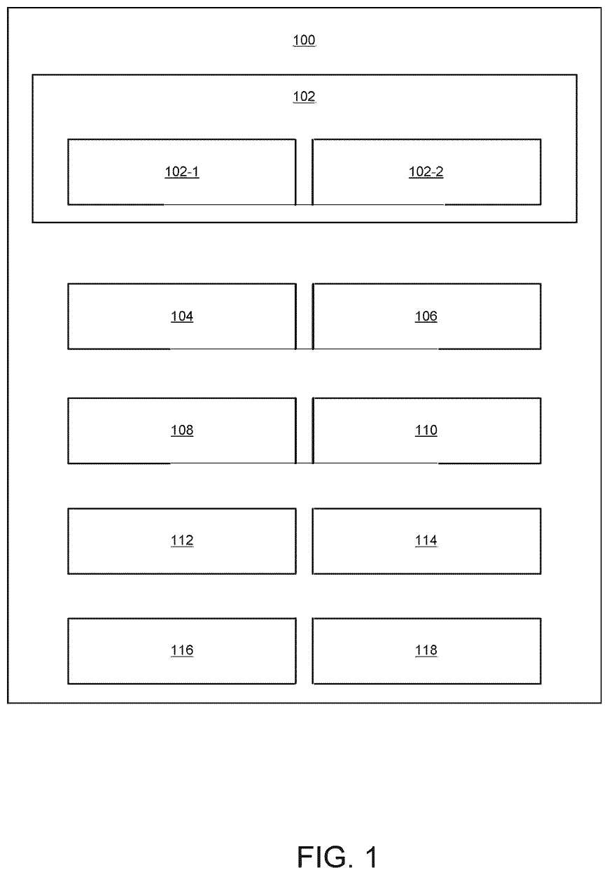

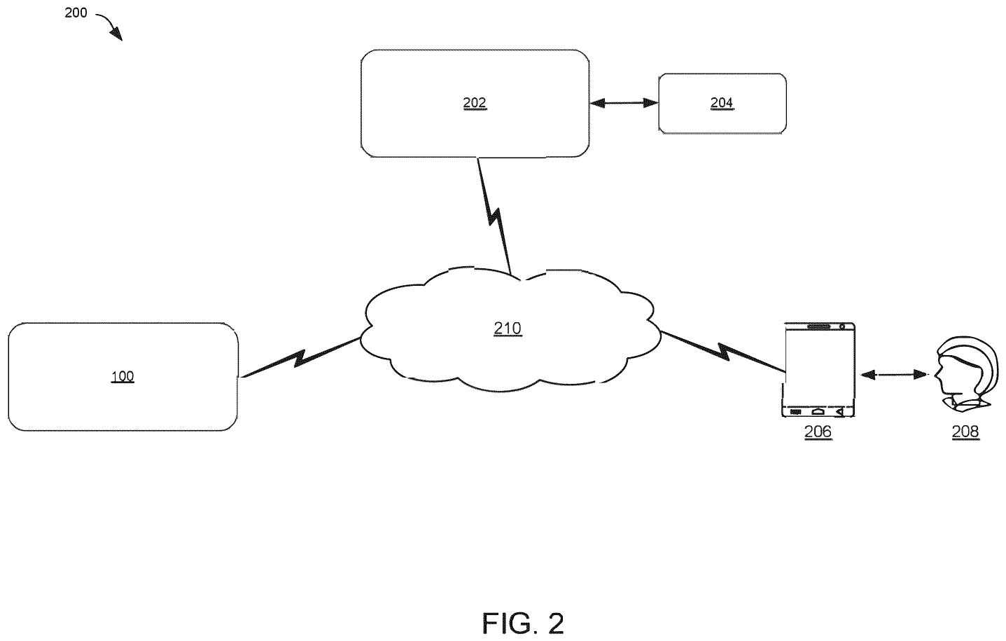

Referring to FIGS. 1 and 2, in an embodiment, the proposed card renewal machine 100 (also referred to as machine 100, herein) is disclosed. The machine 100 can include a processing device 102 that can be in communication with a central server 202 associated with one or more card issuers 204 via a secured network 210 as shown in FIG. 2. The machine 100 can be configured to read the details of various cards associated with different cardholders 208, where the cards may be issued by the card issuers 204. In an exemplary embodiment, the cards may be selected from a debit card, a credit card, and a smart card, but is not limited to the like. The machine 100 can then determine the expiration date of the cards and accordingly destroy or deactivate the card upon completion of the expiration date or upon user's 208 request and further generate a new card for the cardholder 208.

While various embodiments of the present disclosure have been elaborated for renewing and destroying the inserted cards upon expiration of the corresponding card, however, the machine may also renew and destroy a non-expired card, a predefined time period before the actual expiration date upon receiving a renewal request from the registered user or from the card issuer, and all such embodiments are well within the scope of the present disclosure.

In an embodiment, the machine 100 can further include a card reader 104 that can be configured to receive a card inserted within the machine 100 and further extract one or more card details from the inserted card. In an exemplary embodiment, the card reader 104 can be a chip reader configured to read the card details stored in the chip-set of the card. However, the card reader 104 can also be a magnetic strip reader to read the card details stored in a magnetic strip provided on the card. In another exemplary embodiment, the card details may include but are not limited to the name and bank account number of a registered user 208 (also referred to as cardholder), card expiration date or validity period of the card, card type, one or more encoded information, and details of the card issuer 204 and respective banking system.

Further, the processing device 102 can be configured to retrieve, from the central server 202, one or more user details of a registered user 208 associated with the inserted card based on the extracted card details. In an exemplary embodiment, the user details may include but are not limited to name, address, unique identification number, registered mobile number, and card PIN set by the registered user/cardholder 208.

Furthermore, the processing device 102 can be configured to authenticate, using one or more authentication modes, the inserted card and the registered user 208 based on the extracted card details and/or the retrieved user details. In addition, the processing device 102 can extract the expiration date of the received card from the extracted card details and correspondingly mark the received card as an expired card upon completion of the expiration date.

In an embodiment, once the user 208 is authenticated and the inserted card is detected to be expired or upon receiving a card renewal request from the user 208, the machine 100 can be configured to destroy or deactivate at least a chip-set area or magnetic strip area of the expired or old card and further generate a new card for the authenticated user 208. In addition, the processing device 102 can be configured to map the new card details with the user details of the registered user 208 and correspondingly transmit the mapped data to the central server 202. Accordingly, the central server 202 or the card issuers 204 can update the card details of the old card with the new card details, which can be used for authenticating and authorizing the registered user 208s in future financial and non-financial transactions during the updated validity period of the new card.

In an embodiment, the machine 100 can include a hole-punching device 106 operatively coupled to the processing device 102. The processing device 102 can be configured to actuate the hole-punching device 106 to receive the card from the card reader 104 and further punch one or more holes in a chip-set area or magnetic strip area of the expired or old card upon expiration of the inserted card and/or upon receiving the card renewal request. In an exemplary embodiment, the machine 100 can include a first set of actuators (not shown) to allow the card reader 104 to receive the inserted card and orient the card in a predefined orientation in front of the card reader 104 for scanning the card details. Further, a second set of actuators (not shown) can be configured within the machine 100 to transfer and orient the scanned card in front of the hole-punching device 106 to punch holes in the chip-set area or magnetic strip area of the card. Finally, a third set of actuators (not shown) can be configured within the machine 100 to transfer the card having the punched hole to an expired card collection tray or reject hopper (not shown) enclosed within the machine 100.

In an embodiment, the hole-punching device 106 can include a punch head movably coupled to a fixed base. Further, a holder can be configured to receive the scanned card from the card reader 104 and secure the received card in a predetermined position and orientation. Furthermore, a drive mechanism can be configured to actuate the punch head to punch the hole(s) in the secured card at the chip-set area or the magnetic strip area. However, in other embodiments, any other type of hole-punching device may also be implemented and all such embodiments are well within the scope of the present disclosure.

While various embodiments of the present disclosure have been elaborated for using a hole-punching device 106 to punch holes in the chip-set area or the magnetic strip area of the card for deactivating the card, however, any other card deactivating or destroying techniques can also be implemented in the proposed machine 100, and all such embodiments are well within the scope of the present disclosure without any limitations. For instance, in some embodiments, the machine 100 may include a cutter to cut the chip-set area or magnetic strip of the old card. Further, in some embodiments, the machine 100 can include an electromagnetic or microwave element configured to internally burn or destroy the chip-set area or magnetic strip of the old card using electromagnetic waves or microwaves. Furthermore, in some embodiments, the machine 100 can include a heating element configured to burn or destroy the chip-set area or magnetic strip of the old card.

In an embodiment, the machine 100 can include a card printing and embossing device 108 operatively coupled to the processing device 102. The processing device 102 can be configured to actuate the card printing and embossing device 108 to receive the new card from a card container storing one or more new cards and further print and/or emboss one or more new card details and/or at least one of the user details of the registered user 208 on the new card upon receiving the card renewal request from the authenticated user 208. In addition, in an embodiment, the machine 100 can include an ejector 110 configured with the card printing and embossing device 108 and operatively coupled to the processing device 102, where the processing device 102 can be configured to actuate the ejector 110 to eject the printed and/or embossed card out of the machine 100 to the registered user 208.

In an embodiment, the machine 100 can include a human-machine interface 112 (HMI 110) comprising an input unit such as a keyboard or touchpad, and a display unit, operatively coupled to the processing device 102. The HMI 110 can be configured to allow the registered user 208 to send the card renewal request to the processing device 102 and further facilitate the registered user 208 in completing the authentication. In some embodiments, the HMI 110 can also include a speaker or an earphone and a microphone to allow the user 208 to communicate with the machine 100, which may allow the registered user 208 to send the card renewal request to the processing device 102 and further facilitate the registered user 208.

In an embodiment, the machine 100 can include a receipt printer 114 operatively coupled to the processing device 102. The processing device 102 can be configured to actuate the receipt printer 114 to print a receipt comprising a confirming message regarding completion of the card renewal and/or the details of the new card, upon destroying of the expired or old card and/or upon ejection of the new card.

In an embodiment, the machine 100 can further include a biometric authentication module 116 operatively coupled to the processing device 102. In an exemplary embodiment, the biometric module 116 can be selected from a group comprising a facial recognition module, a fingerprint sensor, and the like. The processing device 102 can be configured to extract, using the biometric module 116, biometric attributes of the user 208 inserting the card within the machine 100, and further compare the extracted biometric attributes with pre-stored biometric information associated with the registered user 208 of the inserted card. The processing device 102 can correspondingly authenticate the card and the corresponding user 208 upon a positive matching of the extracted biometric attributes with the pre-stored biometric attributes. Otherwise, the machine 100 may generate an alert and eject the inserted card out of the machine 100 upon a negative biometric authentication of the user 208.

In an embodiment, the machine 100 can include a housing or an enclosure defining the shape of the machine 100. The housing can securely enclose one or more components of the machine 100, including the processing, the card reader 104, the hole-punching device 106, the card printing and embossing device 108, the ejector 110, the HMI 110, the receipt printer 114, the biometric module 116, and various other components.

In an embodiment, the housing can include a card insert slot that allows the user 208 to insert the card to be renewed within the machine 100. Further, the card reader 104 can be positioned within the housing behind or adjacent to the card insert slot to receive the inserted card. In addition, the housing can include a card ejection slot that allows the ejection of the new card out of the machine 100 into a tray. Further, the card printing and embossing device 108 and the ejector 110 can be positioned within the housing behind or adjacent to the card ejection slot, which may allow the ejector 110 to the new card out of the machine 100 into the tray. Further, the housing can include one or more cut-outs that can be configured to accommodate the display, the speakers, the microphone, and the keyboard/key pad of the HMI 110 and the biometric module 116 associated with the machine 100, such that these components remain secured to the housing while remaining accessible to the user 208s from outside to communicate with the machine 100.

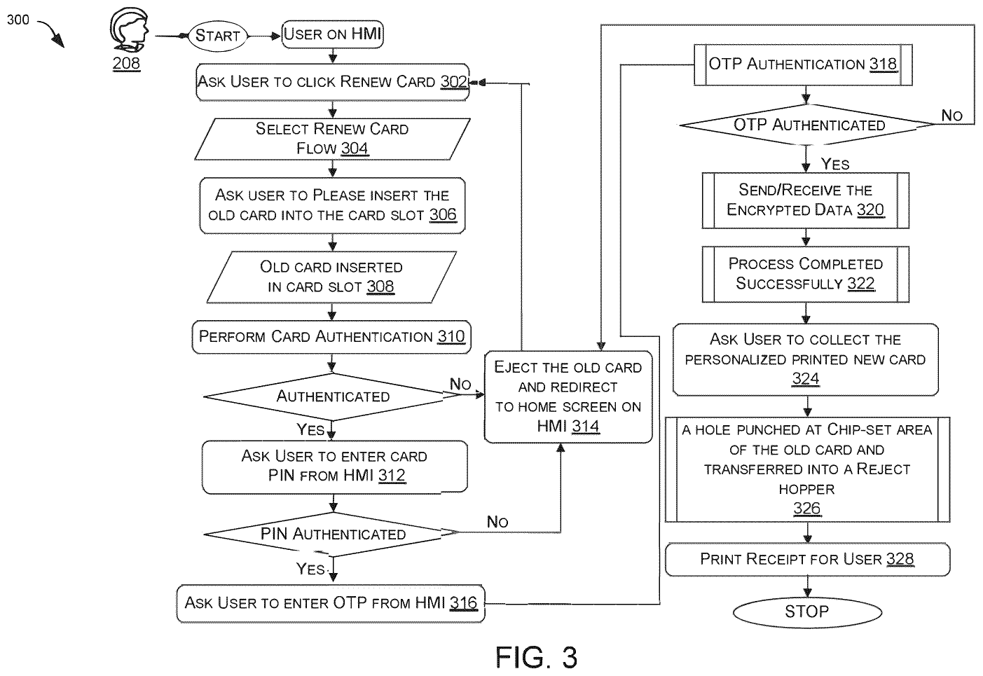

Referring to FIG. 3, an exemplary representation depicting the steps of generating a new card and destroying/deactivating the expired or old card by the proposed machine 100 is disclosed. As illustrated, the HMI 110 of the machine 100 can ask the user 208 (using the display or speaker) to select a “card renew” option at block 302. Once the “card renew” option is selected by the user 208 (using a keypad or voice command by microphone) at block 304, the machine 100 can ask the user 208 to insert the card to be renewed within the card reader 104 via the card insert slot at block 306. Further, once the old card is inserted in the card slot by the user 208 at block 308, the processing device 102 of the machine 100 can authenticate the inserted card at block 310 and further ask the user 208 to enter the card PIN using the HMI 110 at block 312 upon authentication. Otherwise, the machine 100 can eject the inserted card via the same card insert slot at block 314 if the inserted card is not authenticated.

Once the PIN is entered by the user 208, the machine 100 can authenticate the entered PIN by comparing the entered PIN with the pre-stored registered PIN (set by the registered user 208) associated with the same card. Further, the machine 100 can proceed with OTP-based authentication upon successful PIN authentication at blocks 316 and 318. Otherwise, the machine 100 can eject the inserted card via the same card insert slot at block 314 and further send an alert signal to the card issuer and on a registered mobile device 206 associated with the registered user 208. In an embodiment (not shown), the machine 100 can also implement a biometric-based authentication of the user 208 using the biometric module 116, however, biometric-based authentication may also be excluded as well if required.

During the OTP-based authentication, at block 316, the machine 100 can send a one-time password (OTP) on the registered mobile device 206 of the registered user 208 via the secured network 210. The machine 100 can then allow the user 208 to enter the OTP into the machine 100 using the HMI 110. Accordingly, the machine 100 can complete the OTP-based authentication upon OTP authentication or matching at block 318. Otherwise, the machine 100 can eject the inserted card via the same card insert slot at block 314 and send an alert signal to the card issuer 206 and on the registered mobile device 206 of the registered user 208.

Upon successful OTP-based authentication, the machine 100 can exchange encrypted data between the processing device 102, the card, and the central server 202 at block 320. Further, once the data send/receive is completed at block 322, the machine 100 can actuate the card printing and embossing device 108 to print a new card and further provide the new card via the card ejection slot of the machine 100. The machine 100 can ask, using the HMI 110, the user 208 to collect the new card via the tray at block 324. Finally, the machine 100 can actuate the hole-punching device 106 to punch holes in the old or expired card at block 326 to destroy or deactivate the chip-set area of the magnetic strip area of the card and then transfer the destroyed card into the reject hopper. In an embodiment, the machine 100 can actuate the receipt printer 114 to print and provide a receipt comprising a confirming message regarding the completion of the card renewal and/or the details of the new card at block 328, upon destroying the expired or old card and/or upon ejection of the new card.

Thus, the present disclosure provides a simple, secured, and easy-to-use machine 100 for renewing expired or old cards, which provides cardholders with a new card and simultaneously deactivates or destroys the expired or old card, thereby eliminating the risks associated with cardholder details exposure and ensuring that sensitive information remains confidential and protected from unauthorized access.

In an embodiment, referring back to FIG. 2, the machine 100 and the server 202 can be operatively coupled to a website and so be operable from any Internet-enabled mobile device 206 associated with registered users/cardholders 208. Examples of the mobile device 206 may include but are not limited to, a portable computer, a personal digital assistant, a handheld device, and a workstation. The mobile devices 206 of the users 208 and the machine 100 can be communicatively coupled with the server 202 through the network 210.

In one implementation, the network 210 can be a wireless network, a wired network 210 or a combination thereof. The network 210 can be implemented as one of the different types of networks, such as an intranet, local area network (LAN), wide area network (WAN), the internet, and the like. Further, the network 210 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 210 can include a variety of network devices, including routers, bridges, server 202s, computing devices, storage devices, and the like. In another implementation, the network 210 can be a cellular network 210 or mobile communication network 210 based on various technologies, including but not limited to, Global System for Mobile (GSM), General Packet Radio Service (GPRS), Code Division Multiple Access (CDMA), Long Term Evolution (LTE), WiMAX, and the like.

In an aspect, referring back to FIG. 1, the processing device 102 may comprise one or more processor(s) 102-1. The one or more processor(s) 102-1 may be implemented as one or more microprocessors, microcomputers, microcontrollers, digital signal processors, central processing units, logic circuitries, and/or any devices that manipulate data based on operational instructions. Among other capabilities, one or more processor(s) 102-1 are configured to fetch and execute computer-readable instructions stored in a memory 102-2 of the processing device 102, which may cause the processing device 102 to perform one or more designated operations. The memory 102-2 may store one or more computer-readable instructions or routines, which may be fetched and executed to create or share the data units over a network service. The memory 102-2 may comprise any non-transitory storage device including, for example, volatile memory such as RAM, or non-volatile memory such as EPROM, flash memory, and the like.

The processing device 102 may also comprise an interface(s) 118. The interface(s) may comprise a variety of interfaces, for example, interfaces for data input and output devices, referred to as I/O devices, storage devices, and the like. The interface(s) 318 may be a communication module that may facilitate communication of the processing device 102/machine 100 with the server 202. The interface(s) 118 may also provide a communication pathway for one or more components of the processing device 102.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are comprised to enable a person having ordinary skill in the art to make and use the invention when combined with information and knowledge available to the person having ordinary skill in the art.

### Advantages of the Invention

The present invention overcomes the above drawbacks, shortcomings, and limitations associated with existing card renewal solutions.

The present invention establishes a secure and timely renewal process for debit/credit/smart cards, ensuring that the transition from the old to the new card occurs seamlessly and without compromising the security of the cardholder's financial information.

The present invention develops an automated machine that minimizes human intervention in the card renewal process, reducing the chances of errors and improving overall efficiency. This automation streamlines the renewal workflow, from card deactivation to the delivery of the new card to the cardholder.

The present invention has a secure mechanism for deactivating the existing card promptly upon expiration, reducing the window of vulnerability associated with the traditional renewal process. This minimizes the chances of unauthorized access or misuse during the transition period.

The present invention implements robust privacy protection measures and data security protocols throughout the card renewal process. This eliminates the risks associated with cardholder details exposure, ensuring that sensitive information remains confidential and protected from unauthorized access.

The present invention establishes efficient communication channels between the banking institution/card issuers and the cardholder, providing real-time updates on the card renewal process.

The present invention has a user-friendly interface for cardholders to manage and monitor the card renewal process effortlessly.

1. A card renewal machine comprising:
a card reader configured to receive and extract one or more card details pertaining to a card inserted within the machine; and
a processing device in communication with a central server associated with one or more card issuers, the processing device is operatively coupled to the card reader, wherein the processing device is configured to:
receive, from the card reader, the extracted card details pertaining to the inserted card;
retrieve, from the central server, one or more user details of a registered user associated with the inserted card based on the extracted card details;
authenticate, using one or more authentication modes, the inserted card and the registered user based on the extracted card details and/or the retrieved user details; and
extract an expiration date of the received card from the extracted card details and correspondingly mark the received card as an expired card upon completion of the expiration date;
wherein the machine is configured to destroy or deactivate the inserted card and generate a new card upon expiration of the inserted card or upon receiving a card renewal request from the authenticated user.

2. The card renewal machine as claimed in claim 1, wherein the machine comprises a hole-punching device operatively coupled to the processing device,
wherein the processing device is configured to actuate the hole-punching device to receive the card from the card reader and further punch one or more holes in a chip-set area or magnetic strip area of the card upon expiration of the card and/or upon receiving the card renewal request to destroy the card,
wherein the machine is configured to transfer the card having the punched hole to an expired card collection tray enclosed within the machine.

3. The card renewal machine as claimed in claim 1, wherein the machine comprises a card printing and embossing device operatively coupled to the processing device, wherein the processing device is configured to actuate the card printing and embossing device to receive the new card from a card container storing one or more new cards and print and/or emboss one or more new card details and/or at least one of the user details of the registered user on the new card upon receiving the card renewal request from the authenticated user.

4. The card renewal machine as claimed in claim 3, wherein the machine comprises an ejector configured with the card printing and embossing device and operatively coupled to the processing device, wherein the processing device is configured to actuate the ejector to eject the printed and/or embossed card out of the machine to the registered user.

5. The card renewal machine as claimed in claim 3, wherein the processing device is configured to map the one or more new card details with the user details of the registered user and correspondingly transmit the mapped data to the central server, wherein the central server or the one or more card issuers update the card details of the old card with the mapped data or the one or more new card details.

6. The card renewal machine as claimed in claim 3, wherein the machine comprises a human-machine interface (HMI) comprising an input unit and a display unit, operatively coupled to the processing device, wherein the HMI is configured to allow the registered user to send the card renewal request to the processing device and facilitate in completing the authentication during the one or more authentication modes.

7. The card renewal machine as claimed in claim 4, wherein the machine comprises a housing accommodating one or more components of the machine, wherein the housing comprises:
a card insert slot that allows the user to insert the card to be renewed within the machine, wherein the card reader is positioned within the housing behind or adjacent to the card insert slot to receive the inserted card; and
a card ejection slot that allows the ejection of the new card out of the machine into a tray, wherein the card printing and embossing device and the ejector are positioned within the housing behind or adjacent to the card ejection slot.

8. The card renewal machine as claimed in claim 6, wherein the processing device is configured to:
generate and display, on the HMI, a request to the user for entering a unique PIN associated with the card upon inserting the card within the machine, wherein the HMI allows the user to enter the PIN; and
compare the entered PIN with a pre-stored registered PIN associated with the corresponding card and correspondingly authenticate the card and the user upon a positive matching of the entered PIN with the pre-stored registered PIN.

9. The card renewal machine as claimed in claim 8, wherein the processing device is configured to:
generate and transmit, on a registered mobile device associated with the registered user (208) of the inserted card, a unique one-time password (OTP) upon the positive matching, wherein the HMI allows the user to enter the OTP;
compare the entered OTP with the transmitted OTP to authenticate the respective user; and
print the new card and allow the user to collect the printed new card from the machine upon a positive authentication of the user.

10. The card renewal machine as claimed in claim 8, wherein the processing device is configured to generate an alert and eject the inserted card out of the machine upon a negative matching of the entered PIN with the pre-stored registered PIN.
